(19) United States
(12) Patent Application Publication
(10) Pub. No.: US 2011/0072176 A1
(43) Pub. Date: Mar. 24, 2011

(54) METER SYSTEM WITH MASTER/SLAVE METERS

(76) Inventors: Yuan-Yong Hsu, Taipei City (TW); Yung-Hoh Sheu, Taichung City (TW); Chen-Hsiang Kang, Kaohsiung City (TW); Wang-Chang Tsao, Yilan County (TW)

(21) Appl. No.: 12/632,785

(22) Filed: Dec. 7, 2009

(30) Foreign Application Priority Data
Sep. 18, 2009 (TW) 098131615

(51) Int. Cl. G06F 13/00

(52) U.S. Cl. 710/110

(57) ABSTRACT

A meter system includes a CAN-Bus, a master meter, a slave bus, and a slave meter. The master meter includes a first CAN module, a master display, a master communication interface, and a master processor. The master meter is for receiving a signal transmitted from the CAN-Bus and for transforming the signal to a message signal, so as to control the master display to display the corresponding information or to transfer the message signal to the salve bus. The slave meter includes a slave communication interface, a slave display, and a slave processor. The slave meter is for receiving the message signal transmitted from the slave bus and for controlling the slave display to display the corresponding information.

### BACKGROUND OF THE INVENTION

1. Field of the Invention

The present invention relates to a meter system, and more particularly, to a meter system with master/slave meters.

2. Description of the Prior Art

Generally, a conventional digital meter often utilizes a serial peripheral interface (SPI) bus to transmit data. Because each device coupled to the SPI bus has to be set an address by the manufacturer, when the device, such as a digital meter, needs to be modified or a vehicle needs to be exchanged the digital meter, the address of the digital meter is utilized unfavorably and inconveniently. Besides, the SPI bus is limited to the SPI communication protocol, so that the SPI bus is unable to transmit a great quantity of data and only transmits a common control signal, such as the control signal for EEPROM, Flash, a clock, an AD inverter, and so on. The SPI bus does not have a flow control function, which means a host can not detect whether a salve device coupled to the SPI bus is in busy or in free. Additionally, the SPI bus does not have an ACK responding mechanism. Therefore, the SPI bus is mainly used to a single meter system and unsuitable to a multi-meter system.

In addition, the meter system including a built-in communication network system is developing, such as a vehicle communication network utilized in a vehicle meter system. Furthermore, the meter system trends toward a digital system. The manufacturer of the meter system has to set not only parameters as mentioned above, but also resolution of sensing signals, configuration of meter parameters, specification of a sensing signal, and so on before the meter system leaves the factory. Therefore, the meter system is manufactured and designed complicatedly.

### SUMMARY OF THE INVENTION

The present invention provides a meter system with master/slave meters for solving above drawbacks.

According to the claimed invention, the meter system includes a controller area network bus (CAN-Bus) for transmitting a CAN-Bus signal, a master meter coupled to the CAN-Bus, a slave bus coupled to the master meter, and a slave meter. The master meter includes a first controller area network (CAN) module coupled to the CAN-Bus for receiving the CAN-Bus signal transmitted from the CAN-Bus and for transforming the CAN-Bus signal into a message signal, a master instrument panel, a master communication interface, and a master processor coupled to the first CAN module, the master instrument panel, and the master communication interface for receiving the message signal to control the master instrument panel to show information corresponding to the message signal or to transmit the message signal to the master communication interface. The slave bus is for receiving the message signal transmitted from the master communication interface of the master meter. The slave meter includes a slave communication interface coupled to the slave bus for receiving the message signal transmitted from the slave bus, a slave instrument panel, and a slave processor coupled to the slave communication interface and the slave instrument panel for receiving the message signal transmitted from the slave communication interface and for controlling the slave instrument panel to show the information corresponding to the message signal.

According to the claimed invention, the meter system further includes a processing device coupled to the master mater and the slave meter for setting parameters of the master meter and the slave meter. The processing device utilizes a parameter setting bus to set initial functional parameters and application layer protocol parameters of the master meter and the slave meter via a parameter setting interface.

According to the claimed invention, the meter system utilizes the CAN-Bus to transmit the signal between the master meter and the slave meter and sets the parameters with the parameter setting interface of the processing device. Therefore, the meter system is compatible with meters with different specifications so as to form a complete meter system with master/slave meters.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a meter system according to a preferred embodiment of the present invention.

FIG. 2 is a diagram of connection between a master instrument panel and a slave instrument panel according to the preferred embodiment of the present invention.

### DETAILED DESCRIPTION

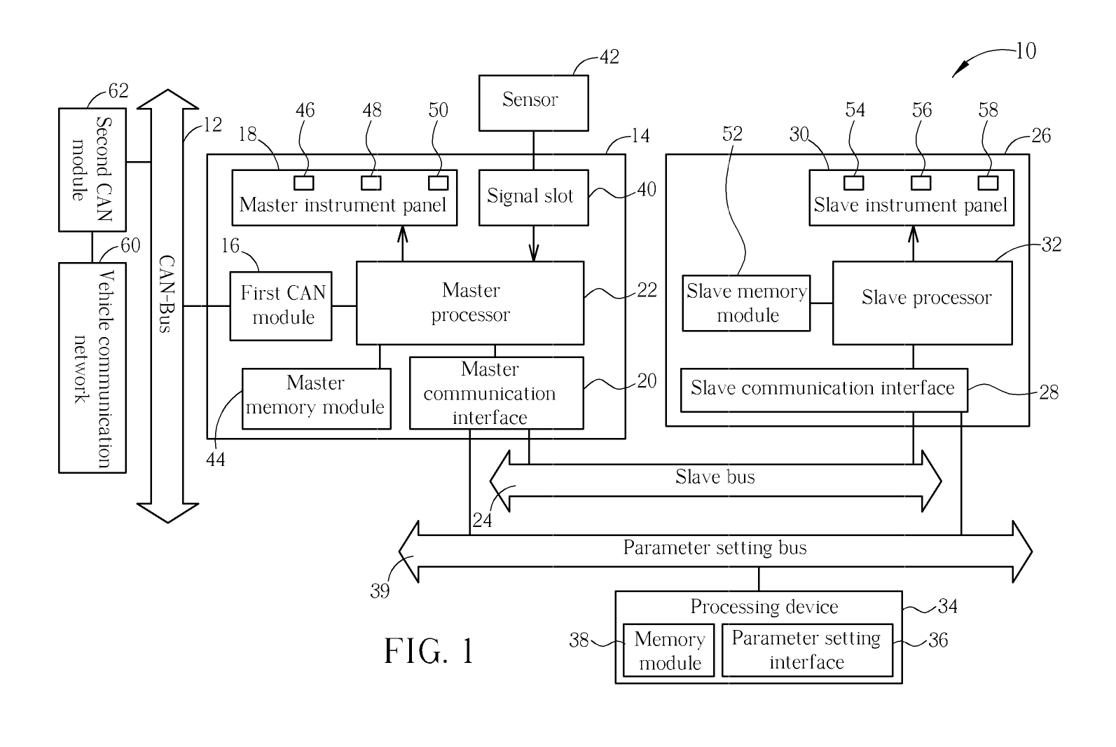

Please refer to FIG. 1. FIG. 1 is a diagram of a meter system 10 according to a preferred embodiment of the present invention. The meter system 10 can be suitable for various transportation, such as vehicles and carriers having meters. The meter system 10 includes a controller area network bus (CAN-Bus) 12 for transmitting a CAN-Bus signal, and a master meter 14 coupled to the CAN-Bus 12. The master meter 14 includes a first CAN module 16 coupled to the CAN-Bus 12 for receiving the CAN-Bus signal transmitted from the CAN-Bus 12 and for transforming the CAN-Bus signal into a message signal, a master instrument panel 18, a master communication interface 20, and a master processor 22 coupled to the first CAN module 16, the master instrument panel 18, and the master communication interface 20 for receiving the message signal to control the master instrument panel 18 to show information corresponding to the message signal or to transmit the message signal to the master communication interface 20. The meter system 10 further includes a slave bus 24 coupled to the master communication interface 20 of the master meter 14 for receiving the message signal transmitted from the master communication interface 20 of the master meter 14, and a slave meter 26 coupled to the slave bus 24. The slave meter 26 includes a slave communication interface 28 coupled to the slave bus 24 for receiving the message signal transmitted from the slave bus 24, a slave instrument panel 30, and a slave processor 32 coupled to the slave communication interface 28 and the slave instrument panel 30 for receiving the message signal transmitted from the slave communication interface 28 to control the slave instrument panel 30 to show the information corresponding to the message signal. The master communication interface 20 of the master meter 14 can conform to an inter-integrated circuit (I²C) communication interface. The master processor 22 of the master meter 14 can control an input/output pin to simulate a I²C signal so as to simulate a function of the I²C communication interface.

In addition, the meter system 10 can further include a processing device 34 coupled to the master mater 14 and the slave meter 26 for setting parameters of the master meter 14 and the slave meter 26. The processing device 34 sets the parameters of initial functions and application layer protocol of the master meter 14 and the slave meter 26 with a parameter setting interface 36. The processing device 34 includes a memory module 38 for storing the parameters of the master meter 14 and the slave meter 26 so as to provide the parameters for the parameter setting interface 36 to set the master meter 14 and the slave meter 26. The parameter setting bus 36 can conform to a CAN-Bus communication interface, the inter-integrated circuit communication interface, or a universal asynchronous receiver-transmitter interface.

The master meter 14 can further include at least one signal slot 40 coupled to at least one sensor 42 for receiving a sensing signal of the sensor 42 and for transmitting the sensing signal of the sensor 42 to the master processor 22. The sensing signal of the sensor 42 can be an analog signal, a digital signal, a frequency signal, a phase signal, and so on. The master meter 14 can further include a master memory module 44 coupled to the master communication interface 20 for storing vehicle driving data. The master instrument panel 18 of the master meter 14 includes a screen 46 for showing a graph or a numeral so as to represent the information corresponding to the message signal. The master instrument panel 18 of the master meter 14 can further include an indicator mechanism 48 driven by a stepping motor for utilizing a pulse width modulation signal to drive the stepping motor. The master instrument panel 18 of the master meter 14 can further include a light emitting diode unit 50 for showing the information corresponding to the message signal by varying intensity of colors. Methods of showing the information by the master instrument panel 18 are not limited to the above-mentioned embodiment and depend on actual demand.

The slave meter 26 can further include a slave memory module 52 coupled to the slave processor 32 for storing an identification code. The slave processor 32 is for reading the identification code so as to analyze the received message signal. The slave communication interface 28 of the slave meter 26 can conform to an I²C communication interface. The slave processor 32 of the slave meter 26 can control an input/output pin to simulate an I²C communication interface signal so as to simulate a function of the I²C communication interface. The salve instrument panel 30 of the slave meter 26 includes a screen 54 for showing a graph or a numeral so as to represent the information corresponding to the message signal. The slave instrument panel 30 of the slave meter 26 further includes an indicator mechanism 56 driven by a stepping motor for utilizing a pulse width modulation signal to drive the stepping motor. The slave instrument panel 30 of the slave meter 26 can further include a light emitting diode unit 58 for showing the information corresponding to the message signal by varying intensity of colors. Methods of showing the information by the slave instrument panel 30 are not limited to the above-mentioned embodiment and depend on actual demand.

In addition, the meter system 10 can further include a vehicle communication network 60 and a second CAN module 62 coupled to the vehicle communication network 60 and the CAN-Bus 12. The second CAN module 62 can transform a signal transmitted from the vehicle communication network 60 into the CAN-Bus signal and transmit the CAN-Bus signal to the CAN-Bus 12. The vehicle communication network 60 can conform to a vehicle communication protocol network, such as a media oriented system transport (MOST) network, a X-by-Wire network, a local interconnect (LIN) network, and so on. The vehicle communication network 60 can be substituted by a vehicle wireless system module, such as a global position system (GPS) unit, a Zigbee wireless network unit, and so on. The vehicle communication network 60 can further be substituted by an on board diagnostics module, and so on.

As mentioned above, because the vehicle communication network 60 transmits the signal to the CAN-Bus 12 with the second CAN module 62, the master meter 14 can receive the CAN-Bus signal corresponding to data generated by the vehicle communication network 60 with the first CAN module 16 coupled to the CAN-Bus 12, and transform the CAN-Bus signal into the corresponding message signal to control the master instrument panel 18 to show the information corresponding to the message signal. Besides, the master meter 14 can receive a general sensing signal of the sensor 42 coupled to the signal slot 40 and control the master instrument panel 18 to show the information corresponding to the sensing signal of the sensor 42. The master instrument panel 18 can show the information generated by the vehicle communication network 60 and the sensor 42 via the CAN-Bus 12 and the signal slot 40.

Furthermore, when the master processor 22 analyzes that the signal transmitted from the CAN-Bus 12 or the signal slot 40 does not conform to a specification of the master instrument panel 18, the master communication interface 20 can transmit the signal to the slave communication interface 28 of the slave meter 26 via the slave bus 24 and control the slave instrument panel 30 to show the information corresponding to the signal transmitted from the CAN-Bus 12 or the signal slot 40. The meter system 10 can utilize the parameter setting interface 36 of the processing device 34 to set the parameters corresponding to different master/slave meters, such as meter parameters, manufacturer data, communication port, CAN parameters, and so on, via a parameter setting bus 39. The function module connected to the CAN-Bus 12 and the slave bus 24 of the present invention are not limited to the above-mentioned components, the function module capable of transmitting the signal via the CAN-Bus 12 and the slave bus 24 is within the scope of the present invention.

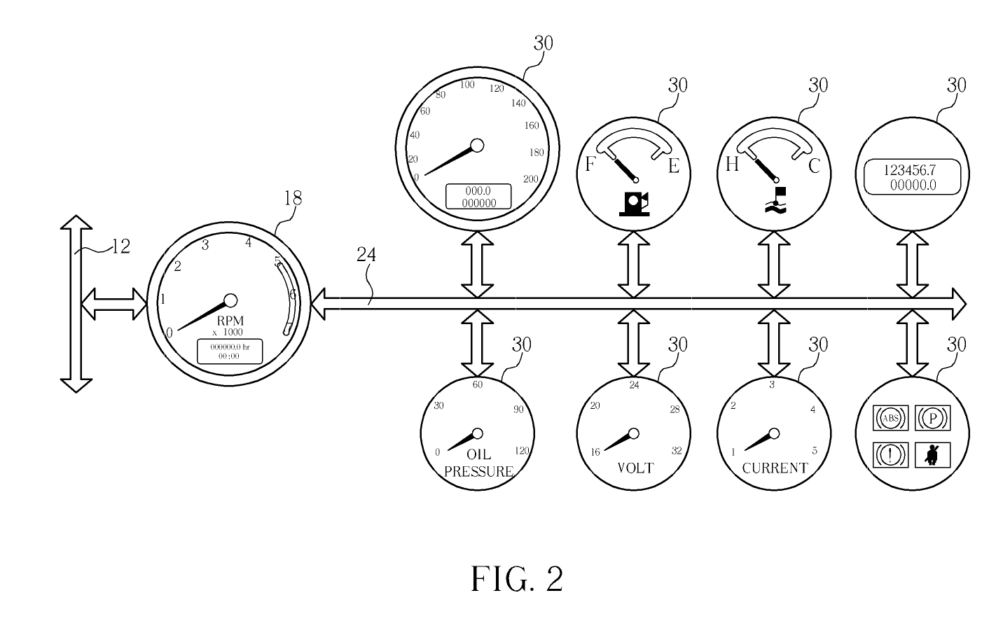

Please refer to FIG. 1 and FIG. 2. FIG. 2 is a diagram of connection between the master instrument panel 18 and the slave instrument panel 30 according to the preferred embodiment of the present invention. The master meter 14 can transmit the CAN-Bus signal by coupling to the CAN-Bus 12 and transmit the sensing signal of the sensor 42 by coupling to the signal slot 40. Therefore, the master meter 14 can show the information corresponding to part of the signal on the master instrument panel 18 and transmit the other CAN-Bus signal or the sensing signal to the slave meter 26 via the slave bus 24, so that the slave instrument panel 30 can show the corresponding information. The master instrument panel 18 can be selected from a group consisting of a speedometer, a tachometer, a fuel level meter, a coolant water temperature meter, an oil pressure meter, a voltmeter, an ammeter, a vacuum gauge, an alarm indicator, and combination thereof. The salve instrument panel 30 can be selected from a group consisting of a speedometer, a tachometer, a fuel level meter, a coolant water temperature meter, an oil pressure meter, a voltmeter, an ammeter, a vacuum gauge, an alarm indicator, and combination thereof. Collocation of the master instrument panel 18 and the slave instrument panel 30 can be designed according to the actual demand.

Comparing to the prior art, the master meter of the meter system of the present invention not only can utilize the CAN-Bus to transmit the CAN-Bus signal, but also can utilize the signal slot to transmit the sensing signal of the sensor, so as to transmit signals effectively and to solve drawbacks of information exchange of conventional electronic modules. The master meter and the slave meter have the communication interfaces with same specification and couple to the slave bus, respectively, so that the master meter and the slave meter can transmit the signal with each other via the slave bus. In addition, the meter system of the present invention can set the parameters of the master meter and the slave mater with the parameter setting interface of the processing device, so as to decrease complexity of the post production of the meter system and working hours of assembly and setting.

Those skilled in the art will readily observe that numerous modifications and alterations of the device and method may be made while retaining the teachings of the invention.

What is claimed is:

1. A meter system comprising:
a controller area network bus (CAN-Bus) for transmitting a CAN-Bus signal;
a master meter coupled to the CAN-Bus, the master meter comprising:
a first controller area network (CAN) module coupled to the CAN-Bus for receiving the CAN-Bus signal transmitted from the CAN-Bus and for transforming the CAN-Bus signal into a message signal;
a master instrument panel;
a master communication interface; and
a master processor coupled to the first CAN module, the master instrument panel, and the master communication interface for receiving the message signal to control the master instrument panel to show information corresponding to the message signal or to transmit the message signal to the master communication interface;
a slave bus coupled to the master communication interface of the master meter for receiving the message signal transmitted from the master communication interface of the master meter; and
a slave meter comprising:
a slave communication interface coupled to the slave bus for receiving the message signal transmitted from the slave bus;
a slave instrument panel; and
a slave processor coupled to the slave communication interface and the slave instrument panel for receiving the message signal transmitted from the slave communication interface and for controlling the slave instrument panel to show the information corresponding to the message signal.

2. The meter system of claim 1 further comprising:
a vehicle communication network; and
a second controller area network module coupled to the vehicle communication network and the CAN-Bus for transforming a signal transmitted from the vehicle communication network into the CAN-Bus signal and for transmitting the CAN-Bus signal to the CAN-Bus.

3. The meter system of claim 1, wherein the master meter further comprises a signal slot coupled to a sensor for receiving a signal of the sensor and for transmitting the signal of the sensor to the master processor.

4. The meter system of claim 1, wherein the master meter further comprises a master memory module coupled to the master communication interface for storing vehicle driving data.

5. The meter system of claim 1, wherein the master communication interface of the master meter conforms to an inter-integrated circuit (I²C) communication interface.

6. The meter system of claim 1, wherein the master processor of the master meter is for controlling an input/output pin to simulate an inter-integrated circuit communication interface signal so as to simulate a function of an inter-integrated circuit communication interface.

7. The meter system of claim 1, wherein the master instrument panel of the master meter comprises a screen for showing a graph or a numeral so as to represent the information corresponding to the message signal.

8. The meter system of claim 1, wherein the master instrument panel of the master meter comprises an indicator mechanism driven by a stepping motor.

9. The meter system of claim 8, wherein the indicator mechanism utilizes a pulse width modulation signal to drive the stepping motor.

10. The meter system of claim 1, wherein the master instrument panel of the master meter comprises a light emitting diode unit for showing the information corresponding to the message signal by varying intensity of colors.

11. The meter system of claim 1, wherein the slave meter further comprises a slave memory module coupled to the slave processor for storing an identification code, the slave processor being for reading the identification code to analyze the received message signal.

12. The meter system of claim 1, wherein the slave communication interface of the slave meter is an inter-integrated circuit communication interface.

13. The meter system of claim 1, wherein the slave processor of the slave meter is for controlling an input/output pin to simulate an inter-integrated circuit communication interface signal so as to simulate a function of an inter-integrated circuit communication interface.

14. The meter system of claim 1, wherein the salve instrument panel of the slave meter comprises a screen for showing a graph or a numeral so as to represent the information corresponding to the message signal.

15. The meter system of claim 1, wherein the slave instrument panel of the slave meter comprises an indicator mechanism driven by a stepping motor.

16. The meter system of claim 15, wherein the indicator mechanism utilizes a pulse width modulation signal to drive the stepping motor.

17. The meter system of claim 1, wherein the slave instrument panel of the slave meter comprises a light emitting diode unit for showing the information corresponding to the message signal by varying intensity of colors.

18. The meter system of claim 1 further comprising:
a processing device coupled to the master mater and the slave meter for setting parameters of the master meter and the slave meter.

19. The meter system of claim 18, wherein the processing device utilizes a parameter setting bus to set initial functional parameters and application layer protocol parameters of the master meter and the slave meter via a parameter setting interface.

20. The meter system of claim 19, wherein the processing device comprises a memory module for storing the parameters of the master meter and the slave meter so as to provide parameters for the parameter setting interface to set the master meter and the slave meter.

21. The meter system of claim 19, wherein the parameter setting bus interface conforms to a CAN-Bus communication interface, an inter-integrated circuit communication interface, or a universal asynchronous receiver-transmitter interface.

22. The meter system of claim 1, wherein the master instrument panel is selected from a group consisting of a speedometer, a tachometer, a fuel level meter, a coolant water temperature meter, an oil pressure meter, a voltmeter, an ammeter, a vacuum gauge, an alarm indicator, and combination thereof.

23. The meter system of claim 1, wherein the salve instrument panel is selected from a group consisting of a speedometer, a tachometer, a fuel level meter, a coolant water temperature meter, an oil pressure meter, a voltmeter, an ammeter, a vacuum gauge, an alarm indicator, and combination thereof.
